(19) United States
(12) Patent Application Publication
(10) Pub. No.: US 2013/0319850 A1
(43) Pub. Date: Dec. 5, 2013

(54) NANOIMPRINT LITHOGRAPHY METHOD FOR MAKING A BIT-PATTERNED MEDIA MAGNETIC RECORDING DISK USING IMPRINT RESIST WITH ENLARGED FEATURE SIZE

(71) Applicant: HGST Netherlands B.V., Amsterdam (NL)

(72) Inventors: Toshiki Hirano, San Jose, CA (US); Dan Saylor Kercher, Santa Cruz, CA (US); Jeffrey S. Lille, Sunnyvale, CA (US); Kanaiyalal Chaturdas Patel, Fremont, CA (US)

(73) Assignee: HGST Netherlands B.V., Amsterdam (NL)

(21) Appl. No.: 13/962,419

(22) Filed: Aug. 8, 2013

Related U.S. Application Data
(62) Division of application No. 12/957,514, filed on Dec. 1, 2010.

(51) Int. Cl. G11B 5/84

(52) U.S. Cl. CPC G11B 5/8404
USPC 204/192.34

(57) ABSTRACT

A method for making a patterned-media magnetic recording disk using nanoimprint lithography (NIL) enlarges the size of the imprint resist features after the imprint resist has been patterned by NIL. The layer of imprint resist material is deposited on a disk blank, which may have the magnetic layer already deposited on it. The imprint resist layer is patterned by NIL, resulting in a plurality of spaced-apart resist pillars with sloped sidewalls from the top to the base. An overlayer of a material like a fluorocarbon polymer is deposited over the patterned resist layer, including over the sloped resist pillar sidewalls. This enlarges the lateral dimension of the resist pillars. The overlayer is then etched to leave the overlayer on the sloped resist pillar sidewalls while exposing the disk blank in the spaces between the resist pillars. The resist pillars with overlayer on the sloped resist pillar sidewalls is then used as a mask for etching the disk blank, leaving a plurality of discrete islands on the disk blank.

### BACKGROUND OF THE INVENTION

### Related Application

This application is a divisional of application Ser. No. 12/957,514 filed Dec. 1, 2010.

### FIELD OF THE INVENTION

This invention relates generally to bit-patterned media (BPM) magnetic recording disks, and more particularly to a method for making the disks using nanoimprint lithography (NIL).

### DESCRIPTION OF THE RELATED ART

Magnetic recording hard disk drives with patterned magnetic recording media, also called bit-patterned media (BPM), have been proposed to increase data density. In BPM the magnetic recording layer on the disk is patterned into small isolated data islands arranged in concentric data tracks. BPM disks may be perpendicular magnetic recording disks, wherein the magnetization directions of the magnetized regions are perpendicular to or out-of-the-plane of the recording layer. To produce the required magnetic isolation of the patterned data islands, the magnetic moment of the spaces between the islands must be destroyed or substantially reduced to render these spaces essentially nonmagnetic.

Nanoimprint lithography (NIL) has been proposed to form the desired pattern of islands on BPM disks. NIL is based on deforming an imprint resist layer by a master template or mold having the desired nano-scale pattern. The master template is made by a high-resolution lithography tool, such as an electron-beam tool. The substrate to be patterned may be a disk blank formed of an etchable material, like quartz, glass or silicon, or a disk blank with the magnetic recording layer formed on it as a continuous layer. Then the substrate is spin-coated with the imprint resist, such as a thermoplastic polymer, like poly-methylemthacrylate (PMMA). The polymer is then heated above its glass transition temperature. At that temperature, the thermoplastic resist becomes viscous and the nano-scale pattern is reproduced on the imprint resist by imprinting from the template at a relatively high pressure. Once the polymer is cooled, the template is removed from the imprint resist leaving an inverse nano-scale pattern of recesses and spaces on the imprint resist. As an alternative to thermal curing of a thermoplastic polymer, a polymer curable by ultraviolet (UV) light can be used as the imprint resist.

After the imprint resist has been patterned on the substrate, the substrate is then etched, using the patterned imprint resist as a mask, and the resist removed. If the substrate is a disk blank with the magnetic recording layer (and any underlayers or seed layers) already formed on it, then the etching through the imprint resist mask removes portions of the recording layer, leaving the desired pattern of data islands and nonmagnetic spaces. If the substrate is just the disk blank, then the etching through the imprint resist mask removes portions of the disk blank, leaving a pattern of pillars and recesses. The material for any underlayers or seed layers and the magnetic material for the recording layer is then sputter deposited over the pillars and recesses. This results in the desired pattern of magnetic data islands (on the pillars) and nonmagnetic spaces (in the recesses). The recesses may be recessed far enough from the read/write heads to not adversely affect reading or writing, or they may be “poisoned” with a dopant material to render them nonmagnetic.

Nanoimprinting of BPM disks is described by Bandic et al., “Patterned magnetic media: impact of nanoscale patterning on hard disk drives”, Solid State Technology S7+ Suppl. S, SEP 2006; and by Yang et al., “Toward 1 Tdot/in² nanoimprint lithography for magnetic bit-patterned media: Opportunities and challenges”, J. Vac. Sci. Technol. B 26(6), Nov/Dec 2008, pp. 2604-2610.

To achieve areal recording densities of Terabytes/square inch (Tb/in²), the lateral dimension of the islands and the nonmagnetic spaces between the islands are critical dimensions that are required to be extremely small, e.g., between about 10 and 30 nm. Additionally, the these lateral dimensions must be controlled to within a small tolerance. This requires very precise control of the NIL process.

One of the problems that makes NIL difficult at these small dimensions and tolerances is that the imprint resist feature size is generally smaller than the ideal size necessary to make features with the desired dimensions in the etched substrate. This is because the recesses in the master template cannot be too close to each other, which requires that there be a minimum required spacing between the recesses, which reduces the feature size. Additionally, the imprint resist typically shrinks in volume when it is cured, which results in the imprinted resist feature size becoming smaller than the size of the recesses in the template.

What is needed is a method for fabricating BPM disks that uses NIL but enables an enlargement of the imprint resist feature size.

### SUMMARY OF THE INVENTION

The invention relates to a method for making a BPM disk using NIL wherein the size of the imprint resist features is enlarged after the imprint resist has been patterned by NIL. The layer of imprint resist material is deposited on a substrate having a generally planar surface. The imprint resist layer is then patterned by NIL, resulting in a plurality of spaced-apart resist pillars, each of the resist pillars having a top having a lateral dimension parallel to the plane of the substrate surface, a base having a lateral dimension parallel to the plane of the substrate surface greater than the lateral dimension of the top, and generally sloped sidewalls from the top to the base. An overlayer of a material like a fluorocarbon polymer is then deposited over the patterned resist layer, including over the sloped resist pillar sidewalls. This enlarges the lateral dimension of the resist pillars. The overlayer is then etched in a direction substantially vertical to the substrate surface to leave the overlayer on the sloped resist pillar sidewalls while exposing the substrate in the spaces between the resist pillars. The resist pillars with overlayer on the sloped resist pillar sidewalls are thus widened in the lateral dimension and then used as a mask for etching the substrate, leaving a plurality of spaced-apart substrate pillars. The substrate pillars have tops with a lateral dimension generally equal to the lateral dimension of the enlarged resist pillars.

The substrate may be a disk blank with the magnetic recording layer (and any underlayers or seed layers) already formed on it, so that the etching through the mask removes portions of the recording layer, leaving the desired pattern of data islands and nonmagnetic spaces. Alternatively, the substrate may be just the disk blank, so that the etching through the mask removes portions of the disk blank, leaving a pattern of discrete islands and recesses. After removal of the imprint resist material from the etched disk blank, the material for any underlayers or seed layers and the magnetic material for the recording layer is then sputter deposited over the islands and recesses.

For a fuller understanding of the nature and advantages of the present invention, reference should be made to the following detailed description taken together with the accompanying figures.

### BRIEF DESCRIPTION OF THE DRAWING

FIG. 1 is a top view of a magnetic recording disk drive with a bit-patterned media (BPM) magnetic recording disk.

FIG. 2 is a top view of an enlarged portion of a BPM disk showing the detailed arrangement of the data islands.

FIGS. 3A-3C illustrate the prior art method of nanoimprint lithography (NIL) for making BPM disks.

FIGS. 4A-4C illustrate an embodiment of the method according to the present invention for increasing the feature size of imprint resist pillars formed by NIL.

FIG. 5A is a scanning electron microscope (SEM) image of a top view of a patterned imprint resist layer on a substrate, and corresponds to the structure depicted schematically in FIG. 4A.

FIG. 5B is a SEM image of a top view of the patterned imprint resist layer of FIG. 5A after deposition of a fluorocarbon polymer overlayer, and corresponds to the structure depicted schematically in FIG. 4B.

FIGS. 6A-6D illustrate an alternative embodiment of the method according to the present invention for increasing the feature size of imprint resist pillars formed by NIL.

FIG. 7 shows a sectional view of a disk blank that has been etched using the imprint resist mask made according to the invention.

FIG. 8A is a sectional view of a substrate comprising a disk blank with a perpendicular magnetic recording layer (RL) formed on it prior to etching using the imprint resist mask made according to the invention.

FIG. 8B shows a sectional view of the completed BPM disk with the substrate of FIG. 8A after it has been etched using the imprint resist mask made according to the invention.

### DETAILED DESCRIPTION OF THE INVENTION

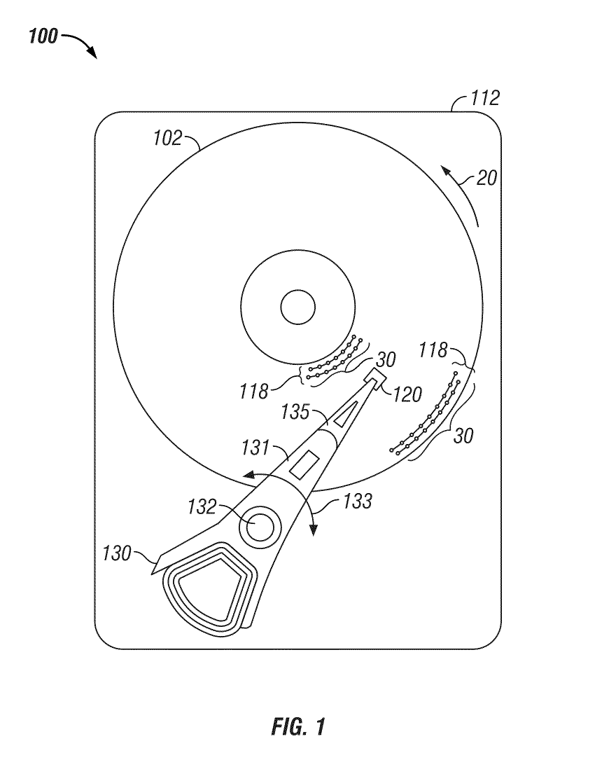

FIG. 1 is a top view of a patterned-media magnetic recording disk drive 100 with a patterned-media magnetic recording disk 102. The drive 100 has a housing or base 112 that supports an actuator 130 and a drive motor for rotating the magnetic recording disk 102. The actuator 130 may be a voice coil motor (VCM) rotary actuator that has a rigid arm 131 and rotates about pivot 132 as shown by arrow 133. A head-suspension assembly includes a suspension 135 that has one end attached to the end of actuator arm 131 and a head carrier, such as an air-bearing slider 120, attached to the other end of suspension 135. The suspension 135 permits the slider 120 to be maintained very close to the surface of disk 102 and enables it to “pitch” and “roll” on the air-bearing generated by the disk 102 as it rotates in the direction of arrow 20. A magnetoresistive read head (not shown) and an inductive write head (not shown) are typically formed as an integrated read/write head patterned as a series of thin films and structures on the trailing end of the slider 120, as is well known in the art. The slider 120 is typically formed of a composite material, such as a composite of alumina/titanium-carbide (Al₂O₃/TiC). Only one disk surface with associated slider and read/write head is shown in FIG. 1, but there are typically multiple disks stacked on a hub that is rotated by a spindle motor, with a separate slider and read/write head associated with each surface of each disk.

The patterned-media magnetic recording disk 102 includes a disk substrate and discrete data islands 30 of magnetizable material on the substrate. The data islands 30 are arranged in radially-spaced circular tracks 118, with only a few islands 30 and representative tracks 118 near the inner and outer diameters of disk 102 being shown in FIG. 1. The islands 30 are depicted as having a circular shape but the islands may have other shapes, for example generally rectangular, oval or elliptical. As the disk 102 rotates in the direction of arrow 20, the movement of actuator 130 allows the read/write head on the trailing end of slider 120 to access different data tracks 118 on disk 102.

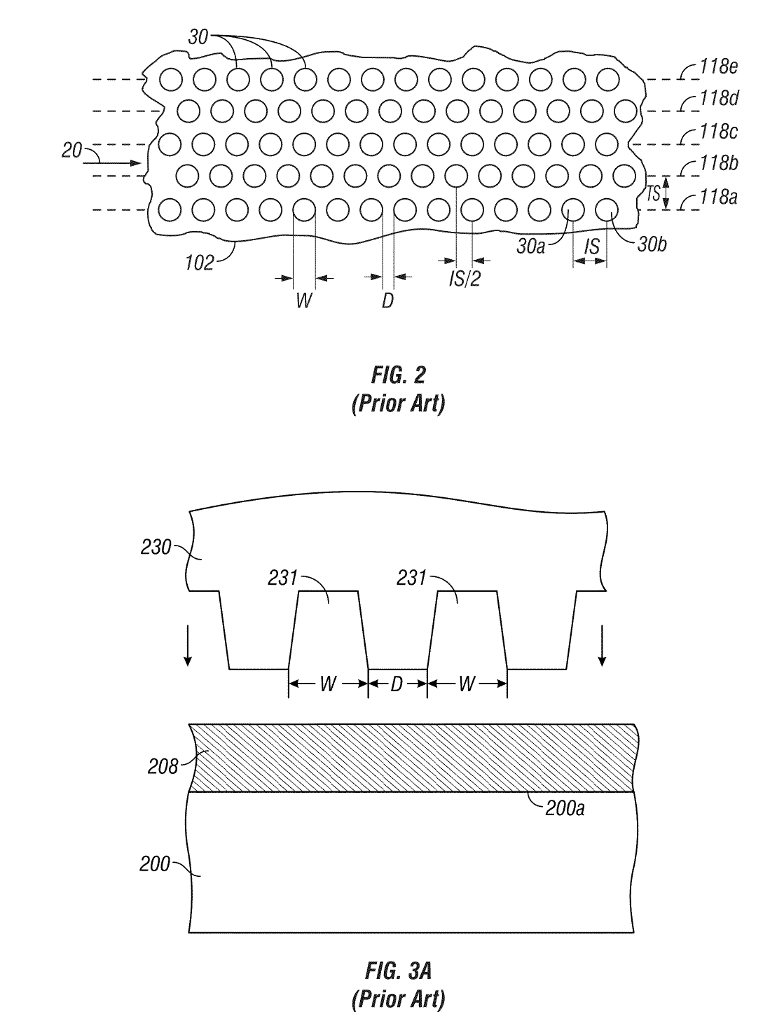

FIG. 2 is a top view of an enlarged portion of disk 102 showing the detailed arrangement of the data islands 30 on the surface of the disk substrate in one type of pattern according to the prior art. The islands 30 contain magnetizable recording material and are arranged in circular tracks spaced-apart in the radial or cross-track direction, as shown by tracks 118a-118e. The tracks are typically equally spaced apart by a fixed track spacing TS. The spacing between data islands in a track is shown by distance IS between data islands 30a and 30b in track 118a, with adjacent tracks being shifted from one another by a distance IS/2, as shown by tracks 118a and 118b. Each island has a lateral dimension W parallel to the plane of the disk 102, with W being the diameter if the islands have a circular shape. The islands may have other shapes, for example generally rectangular, oval or elliptical, in which case the dimension W may be considered to be the smallest dimension of the non-circular island, such as the smaller side of a rectangular island. The adjacent islands are separated by nonmagnetic spaces, with the spaces having a lateral dimension D. The value of D may be greater than the value of W.

BPM disks like that shown in FIG. 2 may be longitudinal magnetic recording disks, wherein the magnetization directions in the magnetizable recording material in islands 30 are parallel to or in-the-plane of the recording layer in the islands, or perpendicular magnetic recording disks, wherein the magnetization directions are perpendicular to or out-of-the-plane of the recording layer in the islands. To produce the required magnetic isolation of the patterned data islands 30, the magnetic moment of the regions or spaces between the islands 30 must be destroyed or substantially reduced to render these spaces essentially nonmagnetic. The term “nonmagnetic” means that the spaces between the islands 30 are formed of a nonferromagnetic material, such as a dielectric, or a material that has no substantial remanent moment in the absence of an applied magnetic field, or a magnetic material in a trench recessed far enough below the islands 30 to not adversely affect reading or writing. The nonmagnetic spaces may also be the absence of magnetic material, such as trenches or recesses in the magnetic recording layer or disk substrate.

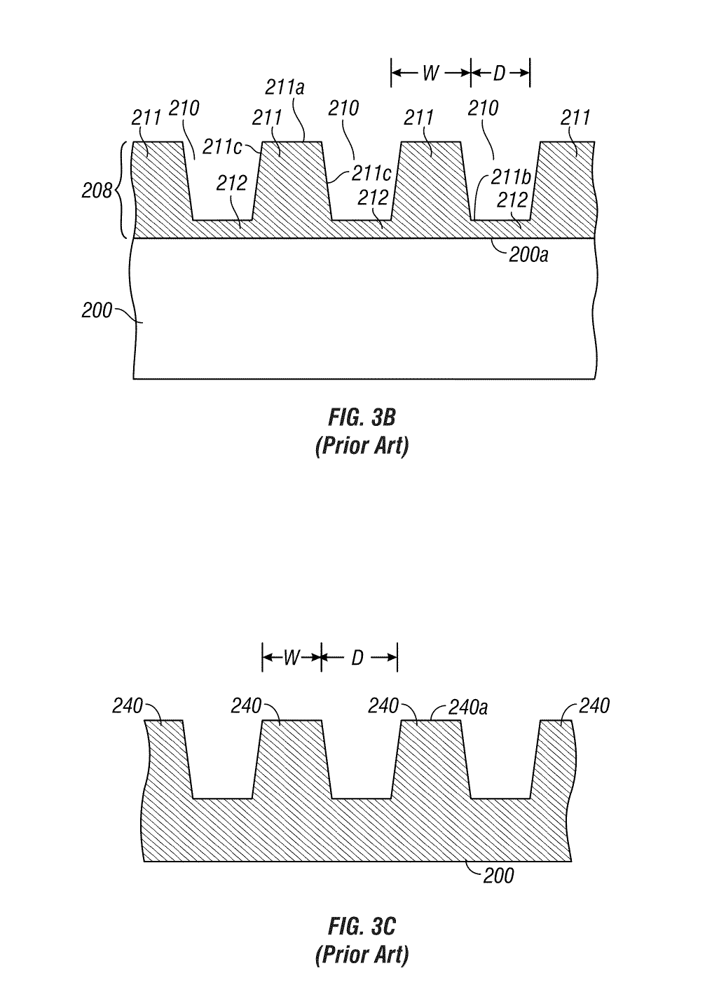

FIGS. 3A-3C illustrate the prior art method of nanoimprint lithography (NIL) for making the BPM disks. In FIG. 3A, a continuous imprint resist layer 208 is deposited on the generally planar surface 200a of substrate 200. The imprint resist layer 208 may be formed of any suitable thermoplastic polymeric material, such as poly-methylmethacrylate (PMMA), or a UV-curable polymer, such as MonoMat available from Molecular Imprints, Inc. A master disk or template 230 is pressed onto the resist layer 208. The master template 230 has a pattern of spaced-apart pits 231 with a lateral dimension W, with the pits being spaced-apart by a distance D. FIG. 3B shows the imprint resist layer 208 after curing and removal of the template 230. The patterned imprint resist layer 208 has a pattern of pillars 211 and recesses 210 that will be replicated in the underlying substrate. As a result of the NIL process, the resist layer 208 will have regions 212 of residual resist material beneath the recesses 210. The resist pillars 211 have a top 211a, a base 211b and generally sloped sidewalls 211c. The resist pillars 211 have a lateral dimension (i.e., parallel to the substrate surface 200a) at their base 211b approximately equal to W and are spaced apart at their base 211b by a lateral dimension approximately equal to D. The patterned resist layer 208 is then used as a mask to etch the underlying substrate 200, which may be a disk blank or a disk blank with the recording layer and underlayers formed on it. The resulting etched substrate 200 is shown in FIG. 3C with substrate pillars 240 that have tops 240a with lateral dimension approximately equal to W, with the substrate pillars 240 being spaced-apart by approximately a distance D. The substrate pillar tops 240a are part of the substrate surface 200a (FIG. 3B).

One of the problems in the NIL fabrication method arises as a result of the need to precisely control the extremely small and critical dimensions of the data islands and their spacing. For example, to achieve areal recording densities of Terabytes/square inch (Tb/in²), the lateral dimension W of the islands, i.e., the diameter for circular-shaped islands 30 (FIG. 2), may be between 10 and 30 nm and the lateral dimension D of the spaces between the islands may be between 5 and 30 nm, with likely values of W and D being between 5 and 20 nm. More importantly, in the completed patterned disk all of the data islands must have the same value of W and all the spaces between the islands must have the same value of D, within a small tolerance.

In NIL, there are several factors that result in the imprint resist feature size (i.e., the size of the resist pillars) being generally smaller than the desired ideal size. The holes or recesses 231 in the master template 230 (FIG. 3A) cannot be too close to each other or they can become connected during fabrication of the template. Thus there is a minimum required gap or spacing between two adjacent recesses in the template, which reduces the feature size. Additionally, the imprint resist typically shrinks in volume when it is cured, which results in the imprinted resist feature size becoming smaller than the size of the recesses in the template. Also, the resist pillars 211 have sloped sidewalls 211c and thus a generally trapezoidal cross-section (FIG. 3B). During the etching step to pattern the substrate, using the patterned imprint resist layer as the mask, the height of the resist pillars may be reduced and portions of the resist pillar sidewalls may be removed, which also results in a reduction in feature size.

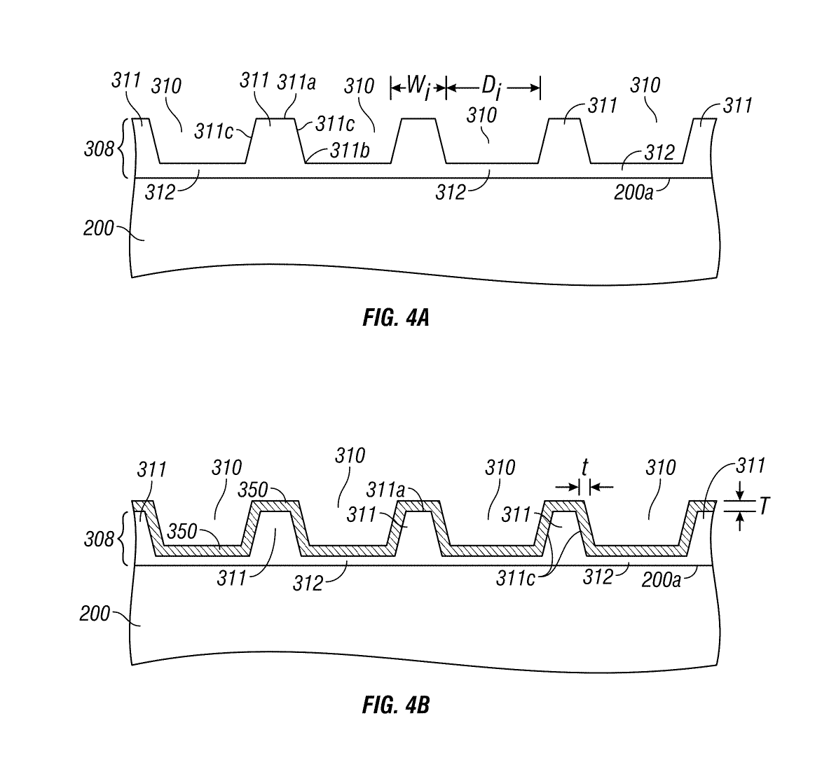

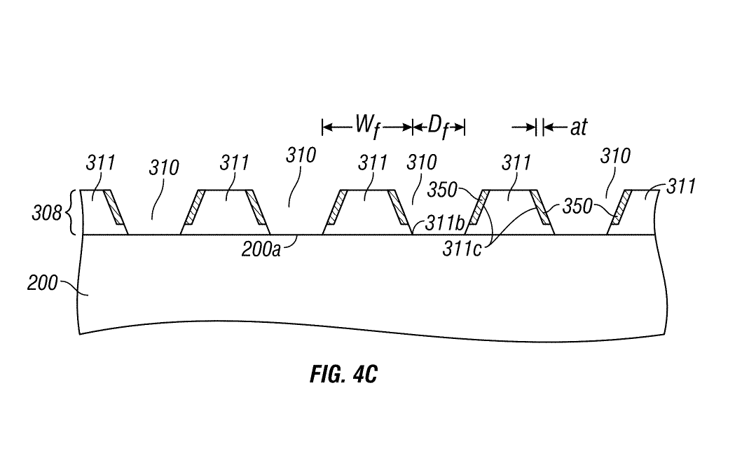

In this invention the completed BPM disk with data islands having the desired values of W and D is obtained by increasing the feature size of the resist pillars after the imprint resist has been patterned by NIL. An embodiment of the method according to the present invention is illustrated in FIGS. 4A-4C. FIG. 4A shows the imprint resist layer 308 on the surface 200a of substrate 200 after curing and removal of the master template. The patterned imprint resist layer 308 has a pattern of pillars 311 and recesses 310 with regions 312 of residual resist material beneath the recesses 310. The imprint resist layer 308 may have a total thickness of 20 to 30 nm with the thickness of the residual resist regions 312 being between about 5 to 10 nm. The resist pillars 311 have a top 311a, a base 311b and generally sloped sidewalls 311c. The resist pillars 311 have a lateral dimension (i.e., parallel to the substrate surface 200a) at their base 311b approximately equal to Wᵢ and are spaced apart at their base 311b by a lateral dimension approximately equal to Dᵢ, where Wᵢ and Dᵢ are initial values of these dimensions that result from similar dimensions in the master template.

In FIG. 4B, an overlayer 350 is deposited over the resist pillars 311, including the resist pillar sidewalls 311c, and into the recesses 310 onto residual resist material 312. The overlayer 350 may be a fluorocarbon polymer that may be deposited by plasma-enhanced chemical vapor deposition (PECVD) from a fluorocarbon (CₓF_{y}) gas like C₄F₈ or C₄F₆. The overlayer may also be carbon or a hydrocarbon polymer deposited by PECVD. The overlayer 350 is deposited to a thickness T on the resist pillar tops 311a and on residual resist regions 312 in the recesses 310. The thickness T may be between about 5 to 10 nm. However, the thickness t of the overlayer 350 on the resist pillar sidewalls 311c is typically thinner than T, as a result of the PECVD process and the slope of the sidewalls 311c.

In FIG. 4C a directional etch orthogonal to substrate surface 210a has removed the overlayer and residual resist regions in recesses 310, as well as the overlayer from the tops of the resist pillars and a portion of the resist from the tops of the resist pillars 311, exposing the substrate surface 200a in the recesses 310. The etching may be by reactive ion etching (RIE) in an oxygen (O₂) plasma. The RIE may also be performed with gases other than oxygen, like CO₂ or a hydrogen/argon mixture. During RIE a large voltage difference occurs between two electrodes, one of which is the platen supporting the substrate 200, resulting in ions being directed toward the substrate and reacting with the overlayer material and resist material. The imprint resist material and the overlayer material should not have significantly different etch rates. It is desirable that their etch rates be within about 50%, i.e., the etch rate for the material with the faster etch rate should not be more than 1.5 times that of the material with the slower etch rate. This will assure that the top surface of the pillars is reasonably flat. If the imprint resist material etches much faster than the overlayer material the resulting resist pillars will have a ring-shaped fence around the periphery. If the overlayer material etches much faster than the imprint resist material the resulting pillars will have a two-step cross-sectional shape with a higher portion in the center.

However, because the etching is orthogonal to the substrate surface 200a, only a portion of the overlayer has been removed from the resist pillar sidewalls 311c, with the remaining overlayer on the sidewalls having a wall thickness approximately αt, where α is some fraction of t remaining after the etching. The resist pillars 311 have thus been widened or enlarged in the lateral dimension at the base 311b by approximately twice the overlayer wall thickness, and now have a lateral dimension at the base 311b of W_{f}, where W_{f} is approximately equal to Wᵢ+2αt. The resist pillars are now spaced apart at their base 311b by a lateral dimension approximately equal to D_{f}. The values oft and a can be determined experimentally and then used to design the master template with the desired values of Wᵢ and Dᵢ to produce the optimum enlarged size of the resist pillars 311. The dimension Wᵢ of the original imprint resist pillars is determined by imprint template limitations and resist shrinkage. The dimension W_{f} of the final imprint resist pillar is determined from the desired magnetic recording performance because there is an optimum lateral dimension of the pillars that delivers the desired data density. The thickness t of the overlayer can be adjusted by adjusting the deposition conditions. Since W_{f}=Wᵢ+2αt, t can be selected such that t=(W_{f}−Wᵢ)/(2α). The correction factor a can be determined experimentally. Alternatively, a series of experiment can be run with different overlayer thicknesses, e.g., t1, t2, t3, etc., and the best thickness selected that gives the desired value of W_{f}. The resulting patterned resist 308 shown in FIG. 4C is the mask for etching of the substrate 200. Thus, after etching of the substrate 200, the tops of the substrate pillars (like the pillars 240 in the prior art of FIG. 3C) will be generally coplanar with the substrate surface 200a and will have a lateral dimension generally equal to the lateral dimension W_{f} of the base 311b of the enlarged resist pillars 311.

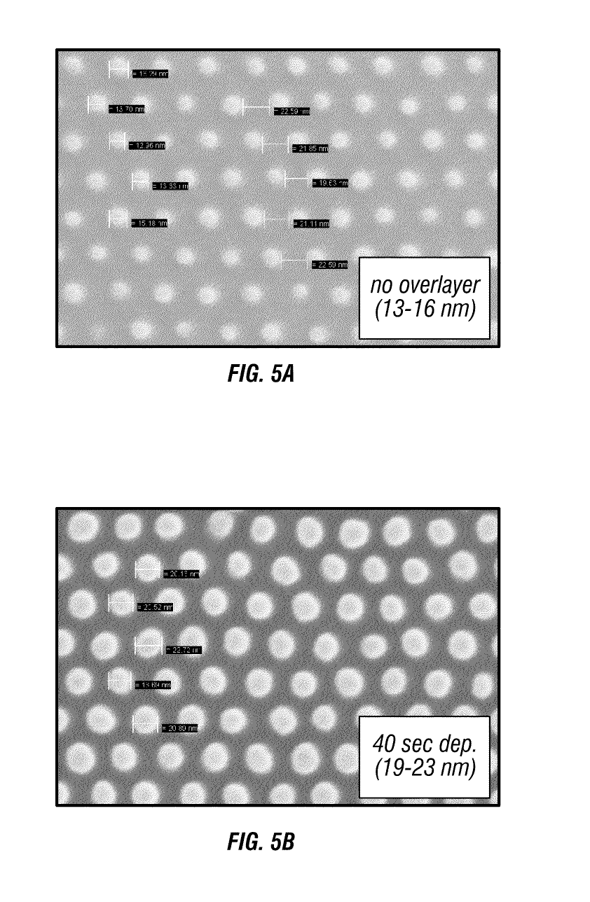

FIG. 5A is a scanning electron microscope (SEM) image of a top view of a patterned imprint resist layer on a substrate, and corresponds to the structure depicted schematically in FIG. 4A. The white dots are resist pillars and have a lateral dimension Wᵢ at the base of between 13-16 nm with a spacing Dᵢ of between 20-23 nm. FIG. 5B is a SEM image of a top view of a the patterned imprint resist layer of FIG. 5A after deposition of a fluorocarbon polymer overlayer, and corresponds to the structure depicted schematically in FIG. 4B. The overlayer was deposited by PECVD of C₄F₆ for approximately 40 sec. The white dots are resist pillars with the overlayer on top and have a lateral dimension of approximately Wᵢ+2t at the base of between 19-23 nm with a spacing D of between 14-17 nm.

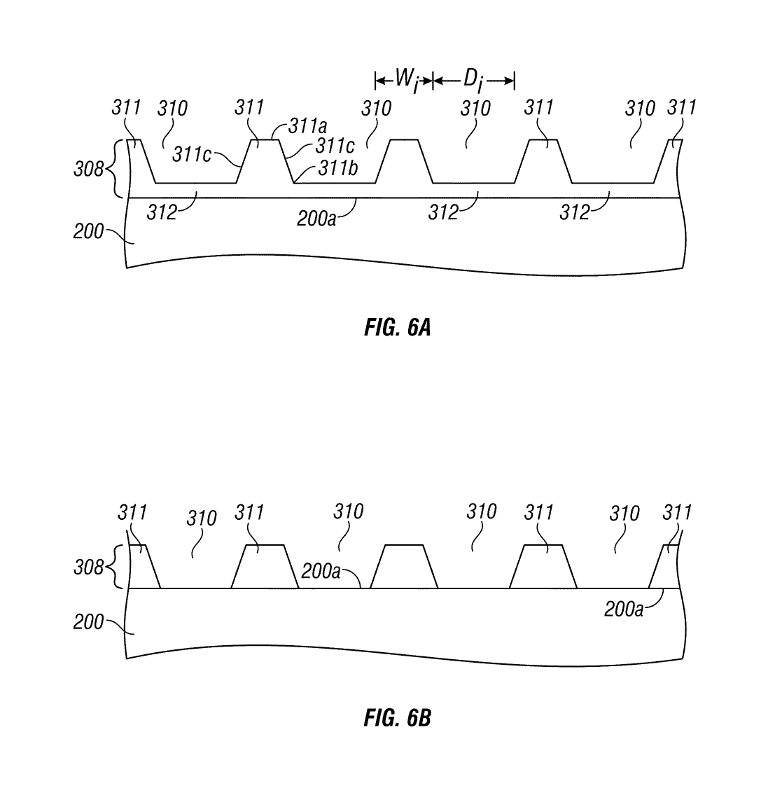

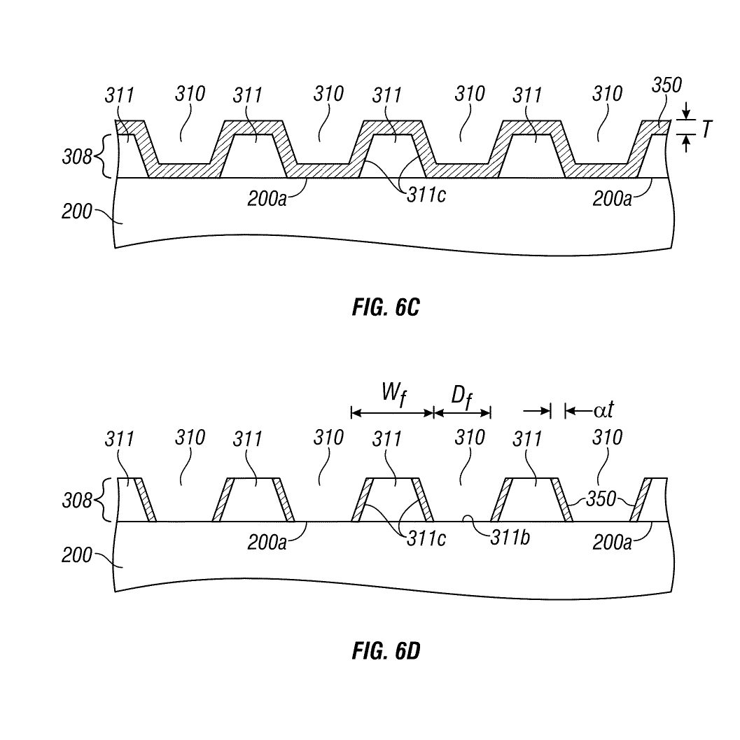

FIGS. 6A-6D illustrate an alternative embodiment of the method according to the present invention for increasing the feature size of imprint resist pillars formed by NIL. FIG. 6A is identical to FIG. 4A and shows the imprint resist layer 308 after curing and removal of the master template. FIG. 6B shows the patterned resist after directional RIE in an oxygen plasma to remove the residual resist regions 312 and a portion of the resist material on the tops of pillars 311, exposing the substrate surface 200a. In FIG. 6C, the overlayer 350 is deposited over the resist pillars 311, including the resist pillar sidewalls 311c, and onto the substrate surface in the recesses 310. In FIG. 6D a directional etch orthogonal to substrate surface 210a has removed the overlayer from the tops of the resist pillars and from the recesses 310, exposing the substrate surface 200a in the recesses 310. However, as in FIG. 4C, because the etching is orthogonal to the substrate surface 200a, only a portion of the overlayer has been removed from the resist pillar sidewalls 311c. The resist pillars 311 have thus been widened or enlarged in the lateral dimension at the base 311b. The resulting patterned resist 308 shown in FIG. 6D is the mask for etching of the substrate 200. Thus, after etching of the substrate 200, the tops of the substrate pillars (like the pillars 240 in the prior art of FIG. 3C) will be generally coplanar with the substrate surface 200a and will have a lateral dimension generally equal to the lateral dimension W_{f} of the base 311b of the enlarged resist pillars 311.

The methods of the invention as described above can be performed with little impact to overall disk manufacturing process time, which is important for high-volume mass-production of patterned media disks. The ability to deposit the overlayer and perform the etching in less than one minute is important. The preferred process is one where the deposition and etching are both performed in the same chamber without transporting the disks. Alternatively, the process can use a sequence of chambers where deposition is performed in one chamber and the etching in a second chamber, with the disks being transported to the second chamber without breaking vacuum.

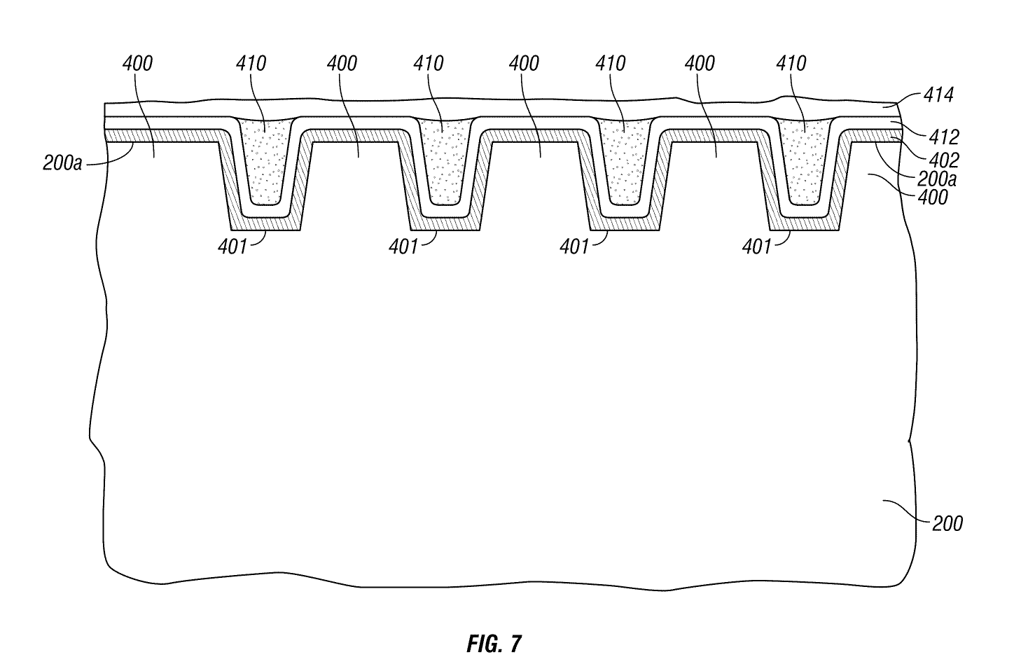

As described previously, the substrate 200 to be patterned may be a disk blank formed of an etchable material, like quartz, glass or silicon, or a disk blank with the magnetic recording layer formed on it as a continuous layer. FIG. 7 shows a sectional view of a disk blank 200 that has been etched using the imprint resist mask made according to the invention, as depicted in FIG. 4C or FIG. 6D, to create a pattern of pillars 400 and recesses 401. The disk blank 200 may be any conventional disk blank, such as one formed of quartz, glass or silicon. A magnetic layer 402, for example a CoPtCr alloy with perpendicular magnetic anisotropy, is deposited on the etched disk blank 200 on the substrate surface 200a over the pillars 400 and into the recesses 401. One or more seed layers or underlayers (not shown) may be deposited on the disk blank 200 prior to the deposition of magnetic layer 402. The magnetic layer has a typical thickness in the range of about 10 to 50 nm. A protective overcoat 412, such as an amorphous carbon overcoat, is deposited over the magnetic layer 402. The recesses 401 may then be filled with a fill material 410, like SiO₂, to planarize the disk surface. A liquid lubricant layer 414 may then be applied over the planarized disk surface.

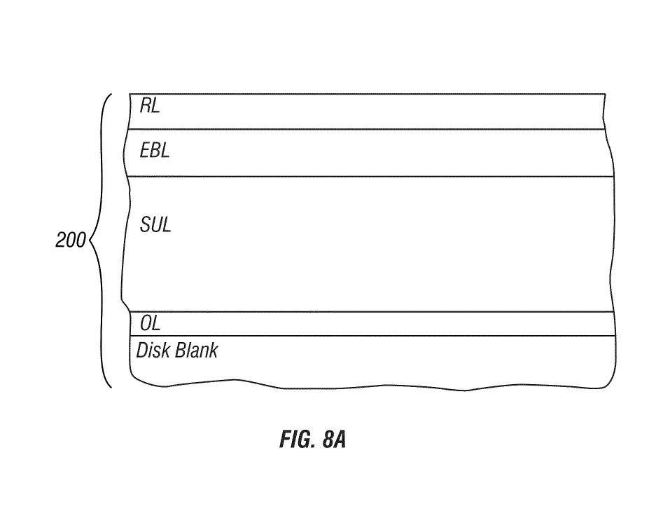

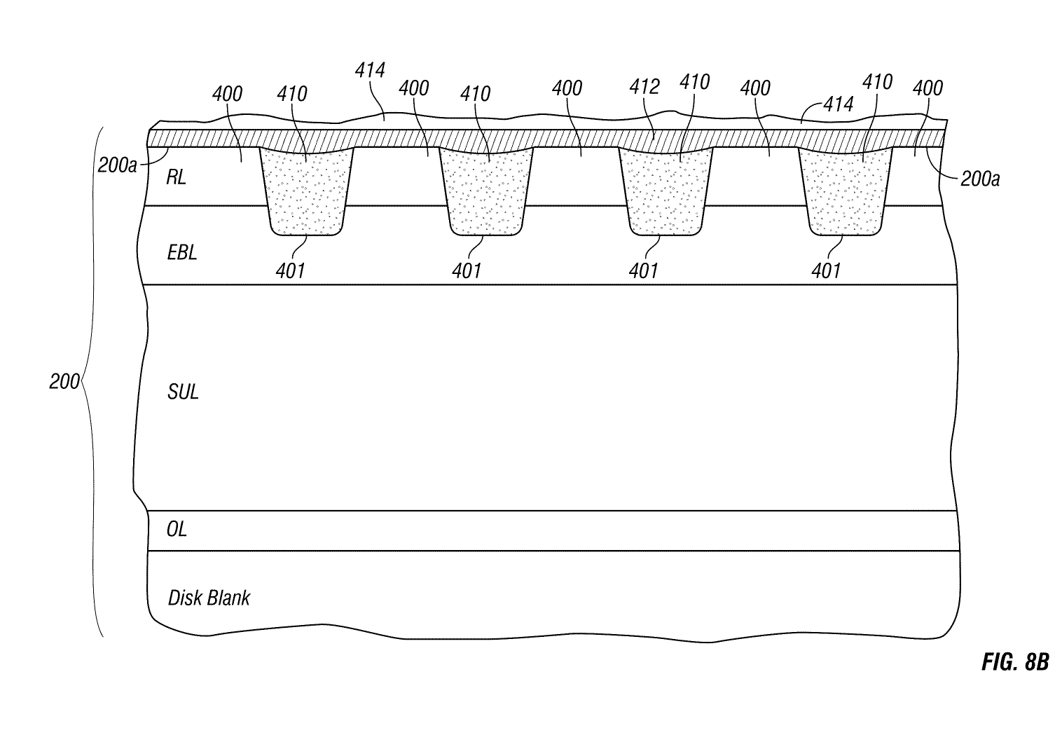

FIG. 8A is a sectional view of a substrate 200 comprising a disk blank with a perpendicular magnetic recording layer (RL) formed on it prior to etching using the imprint resist mask shown in FIG. 4C or FIG. 6D. An optional soft magnetic underlayer (SUL) may be located below the RL to serve as a flux return path for the magnetic write field from the disk drive write head. An adhesion layer or onset layer (OL) for the growth of the SUL may be deposited on the disk blank prior to deposition of the SUL. An exchange-break layer (EBL) is typically located on top of the SUL to break the magnetic exchange coupling between the magnetically permeable films of the SUL and the RL and also to facilitate epitaxial growth of the RL. FIG. 8B shows a sectional view of the completed BPM disk with the substrate 200 of FIG. 8A. The etching of substrate 200 of FIG. 8A using the imprint resist as a mask has formed recesses 401, leaving pillars 400 of RL material with an upper surface 200a. The recesses 401 are filled with planarizing material 410. A protective overcoat 412, such as an amorphous carbon overcoat, is deposited over the planarized surface, and a liquid lubricant layer 414 may then be applied over the disk overcoat 412.

While the present invention has been particularly shown and described with reference to the preferred embodiments, it will be understood by those skilled in the art that various changes in form and detail may be made without departing from the spirit and scope of the invention. Accordingly, the disclosed invention is to be considered merely as illustrative and limited in scope only as specified in the appended claims.

What is claimed is:

1. A method for making a bit-patterned media (BPM) magnetic recording disk having discrete data islands of magnetic recording material arranged in concentric tracks, the method comprising:
providing a rigid disk blank having a continuous magnetic recording layer;
depositing a polymeric resist layer on the recording layer surface;
patterning the resist layer by imprint lithography to have a plurality of discrete spaced-apart resist pillars arranged in concentric tracks with residual resist on the recording layer surface between the resist pillars, each of the resist pillars having a top having a lateral dimension parallel to the plane of the recording layer surface, a base having a lateral dimension parallel to the plane of the recording layer surface greater than the lateral dimension of the top, and generally sloped sidewalls from the top to the base;
depositing an overlayer over the patterned resist layer, including over the residual resist and the sloped resist pillar sidewalls;
etching the overlayer in a direction substantially vertical to the recording layer surface to remove the overlayer and underlying residual resist in the spaces between the resist pillars and a portion of the overlayer on the resist pillar sloped sidewalls, leaving exposed recording layer surface in the spaces between the resist pillars and leaving resist pillars having a base on the recording layer surface with a lateral dimension greater than the base lateral dimension prior to overlayer deposition; and
etching the exposed spaces of the recording layer using as a mask the resist pillars with overlayer on the sloped resist pillar sidewalls, leaving a plurality of spaced-apart discrete recording layer pillars arranged in concentric tracks and having tops generally coplanar with said recording layer surface and with a lateral dimension greater than the resist base lateral dimension prior to overlayer etching.

2. The method of claim 1 wherein the method comprises making a BPM disk having data islands with a lateral dimension W_{f} parallel to the plane of the recording layer surface; wherein patterning the resist layer comprises patterning the resist pillars to have a base lateral dimension Wᵢ less than W_{f}; and wherein etching the overlayer comprises etching the overlayer to leave overlayer with a wall thickness on the sloped resist pillar sidewalls, wherein the overlayer wall thickness is approximately (W_{f}−Wᵢ)/2.

3. The method of claim 1 wherein depositing an overlayer comprises depositing a fluorocarbon polymer by plasma-enhanced chemical vapor deposition (PECVD) from a fluorocarbon gas.

4. The method of claim 1 wherein depositing an overlayer comprises depositing a material selected from carbon and a hydrocarbon polymer by plasma-enhanced chemical vapor deposition (PECVD) from a hydrocarbon gas.

5. The method of claim 1 wherein etching the overlayer comprises reactive ion etching (RIE) the overlayer in an oxygen-containing plasma.

6. The method of claim 1 wherein the polymeric resist material and the overlayer material each has an etch rate, and wherein the etch rate for the material with the faster etch rate is less than or equal to 1.5 times the etch rate of the material with the slower etch rate.

7. A method for making a bit-patterned media (BPM) bit-patterned magnetic recording disk having discrete islands arranged in radially spaced tracks comprising:
providing a rigid disk blank having a generally planar surface;
depositing a polymeric resist layer over the disk blank surface;
patterning the resist layer by imprint lithography to have a plurality of spaced-apart resist pillars arranged in radially-spaced tracks, each of the resist pillars having a top having a lateral dimension parallel to the plane of the disk blank surface, a base having a lateral dimension parallel to the plane of the disk blank surface greater than the lateral dimension of the top, and generally sloped sidewalls from the top to the base;
depositing an overlayer over the patterned resist layer, including over the sloped resist pillar sidewalls;
etching the overlayer in a direction substantially vertical to the disk blank surface to leave the overlayer on the sloped resist pillar sidewalls while exposing the disk blank in the spaces between the resist pillars, the resist pillars after overlayer etching having a base at the disk blank surface with a lateral dimension greater than the base lateral dimension prior to overlayer deposition; and
etching the exposed spaces of the disk blank using as a mask the resist pillars with overlayer on the sloped resist pillar sidewalls, leaving a plurality of discrete islands on the disk blank.

8. The method of claim 7 wherein the patterned resist layer has residual resist on the disk blank between the resist pillars, wherein depositing the overlayer comprises depositing the overlayer over the residual resist, and wherein etching the overlayer comprises etching the overlayer and the underlying residual resist.

9. The method of claim 7 further comprising, prior to depositing the overlayer, etching the patterned resist layer substantially vertical to the disk blank surface to remove the resist layer in the spaces between the resist pillars and expose the disk blank in the spaces between the resist pillars; and wherein depositing the overlayer comprises depositing the overlayer onto the disk blank in the spaces between the resist pillars.

10. The method of claim 7 wherein the islands on the disk blank have a lateral dimension W_{f} parallel to the plane of the disk blank surface; wherein patterning the resist layer comprises patterning the resist pillars to have a base lateral dimension Wᵢ less than W_{f}; and wherein etching the overlayer comprises etching the overlayer to leave overlayer with a wall thickness on the sloped resist pillar sidewalls, wherein the overlayer wall thickness is approximately (W_{f}−Wᵢ)/2.

11. The method of claim 7 wherein depositing an overlayer comprises depositing a fluorocarbon polymer by plasma-enhanced chemical vapor deposition (PECVD) from a fluorocarbon gas.

12. The method of claim 7 wherein depositing an overlayer comprises depositing a material selected from carbon and a hydrocarbon polymer by plasma-enhanced chemical vapor deposition (PECVD) from a hydrocarbon gas.

13. The method of claim 7 wherein etching the overlayer comprises reactive ion etching (RIE) the overlayer in an oxygen-containing plasma.

14. The method of claim 7 wherein the polymeric resist material and the overlayer material each has an etch rate, and wherein the etch rate for the material with the faster etch rate is less than or equal to 1.5 times the etch rate of the material with the slower etch rate.

15. The method of claim 7 further comprising, after etching the exposed spaces of the disk blank, removing the resist pillars from the disk blank and thereafter depositing a layer of magnetic recording material over the islands on the disk blank.
